(19) United States
(12) Patent Application Publication
(10) Pub. No.: US 2026/0369097 A1
(43) Pub. Date: Nov. 19, 2026

(54) Reductive Iteration Convolution-Based Keypoint Detection

(71) Applicant: Google LLC, Mountain View, CA (US)

(72) Inventors: Josephine Nordrum, Pueblo West, CA (US); Firas Sammoura, San Ramon, CA (US)

(21) Appl. No.: 19/142,466

(22) PCT Filed: Dec. 27, 2022
(86) PCT No.: PCT/US2022/082414

§ 371 Date: Jun. 23, 2025

(51) Int. Cl. G06V 40/12; G06F 21/32; G06V 10/25; G06V 10/36; G06V 10/44; G06V 10/75; G06V 10/77; G06V 40/50

(52) U.S. Cl. CPC G06V 40/1353; G06F 21/32; G06V 10/25; G06V 10/36; G06V 10/44; G06V 10/751; G06V 10/7715; G06V 40/1371; G06V 40/50

(57) ABSTRACT

A method includes obtaining an input image, and determining a convolution image by convolving the input image with a kernel configured to detect an image feature. The method also includes selecting, from the convolution image, a keypoint pixel based on a corresponding value thereof being within a detection value range. The key-point pixel represents a location within the input image of an instance of the image feature. The method additionally includes updating the convolution image by assigning a neutral value to the keypoint pixel and neighboring pixels positioned at predetermined coordinates relative to the keypoint pixel. The neutral value is excluded from the detection value range. The plurality of neighboring pixels defines a minimum spacing between the keypoint pixel and subsequent keypoint pixels detected based on the convolution image as updated. The method further includes generating an output data that represents the keypoint pixel and the subsequent keypoint pixels.

### BACKGROUND

A fingerprint is an impression left by the ridges of a human finger. Human fingerprints are nearly unique, difficult to alter, and durable over the life of an individual, and are therefore suitable for use as human identifiers. The uniqueness of a fingerprint is based on the overall pattern of ridges and valleys, and/or ridge discontinuities known as minutiae. Minutiae include ridge endings and valley endings, combinations of which may form ridge bifurcations, short/independent ridges, islands/dots, lakes/ridge enclosures, spurs, bridges/crossovers, deltas, and cores. A fingerprint may be used as part of a user authentication process to, for example, determine whether a user is allowed to access a computing system and/or a portion thereof.

### SUMMARY

Instances of a predetermined image feature may be detected within an input image, and may be indicated using keypoint pixels. The input image may represent, for example, a fingerprint, and the predetermined image feature may be a ridge end, valley end, and/or another fingerprint minutia. The input image may be convolved with a kernel having a shape, size, and kernel values that allow for detection of the predetermined image feature, resulting in a convolution image having pixel values that are indicative of a likelihood of corresponding portions of the input image representing the predetermined image feature. A keypoint pixel may be selected from the convolution image based on having a corresponding pixel value that is within a detection value range, and may indicate a location within the input image at which a corresponding instance of the predetermined image feature has been detected. To allow for minimum spacing between detected keypoint pixels, the convolution image may be updated by assigning a neutral value to the keypoint pixel and neighboring pixels positioned at predetermined coordinates relative to the keypoint pixel (e.g., located in a square centered on the keypoint pixel). The keypoint selection may be repeated to identify subsequent keypoint pixels within the convolution image as updated. The neutral value may be outside of the detection value range, and thus the keypoint pixel and the neighboring pixels thereof might not be selectable as keypoint pixels from the convolution image as updated during subsequent iterations of keypoint pixel selection. Output data may be generated that represents the keypoint pixels detected within the input image.

In a first example embodiment, a method may include obtaining an input image that includes a plurality of pixels, and determining a convolution image by convolving the input image with a kernel configured to detect a predetermined image feature. The method may also include selecting, from the convolution image, a keypoint pixel based on determining that a corresponding pixel value of the keypoint pixel is within a detection value range. The keypoint pixel may represent a location within the input image of an instance of the predetermined image feature. The method may additionally include updating the convolution image by assigning a neutral value to (i) the keypoint pixel and (ii) a plurality of neighboring pixels positioned at predetermined coordinates relative to the keypoint pixel. The neutral value may be excluded from the detection value range, and the plurality of neighboring pixels may define a minimum spacing between the keypoint pixel and one or more subsequent keypoint pixels detected based on the convolution image as updated. The method may further include generating an output data that represents the keypoint pixel and the one or more subsequent keypoint pixels.

In a second example embodiment, a system may include a processor and a non-transitory computer-readable medium having stored thereon instructions that, when executed by the processor, cause the processor to perform operations in accordance with the first example embodiment.

In a third example embodiment, a non-transitory computer-readable medium may have stored thereon instructions that, when executed by a computing device, cause the computing device to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a computing device, in accordance with examples described herein.

FIG. 2 illustrates a computing system, in accordance with examples described herein.

FIG. 3 illustrates a keypoint detection system, in accordance with examples described herein.

FIGS. 4A, 4B, 4C, 4D, 4E, 4F, and 4G illustrate convolution images, in accordance with examples described herein.

FIG. 4H illustrates output data, in accordance with examples described herein.

FIGS. 5A and 5B illustrate convolution kernels, in accordance with examples described herein.

FIG. 6 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

A keypoint detection system may be configured to detect one or more instances of a predetermined image feature in an input image that includes a plurality of pixels. The predetermined image feature may include a combination of one or more shapes, such as a circle, rectangle, and/or freeform line, among other possibilities. The predetermined image feature may vary with the application and/or purpose for which the input image is being processed. For example, when the input image represents a fingerprint, the predetermined image feature may include a ridge end, which may be approximated as a circle or a union of a circle and a rectangle. Detection of fingerprint ridge ends may allow the keypoint detection system to identify fingerprint minutiae (i.e., a plurality of fingerprint minutia, with minutia being used herein as the singular form of the plural “minutiae”) to be used in connection with user authentication. In another example, when the input image represents an infrared light illumination pattern, the predetermined image feature may include an infrared dot, which may be approximated as a circle or oval. Detection of the infrared dots may allow the keypoint detection system to facilitate determination of a depth image corresponding to the input image, which may be used in connection with user authentication and/or robotic/vehicular navigation, among other possibilities.

Instances of the predetermined image feature may be identified in the input image by convolving the input image with a kernel that is configured to detect the predetermined image feature, thereby generating a convolution image. Pixel values of the convolution image may indicate a likelihood of a corresponding portion of the input image containing an instance of the predetermined image feature. Keypoint pixels that have values within a detection value range may be selected from the convolution image to represent corresponding instances of the predetermined image feature. For example, when the likelihood of a pixel representing the predetermined image feature is proportional to the pixel value, a keypoint pixel may be selected by identifying a highest valued pixel in the convolution image. Since keypoint pixels represent a keypoint of the predetermined image feature, the terms “keypoint pixel” and “keypoint” may be used synonymously.

In some cases, it may be desirable to maintain a minimum spacing between adjacent keypoint pixels, to distribute the keypoint pixels in a relatively uniform manner across the area of the input image, and/or prevent the keypoint pixels from being clumped or clustered in a portion of the input image. Further, it may be desirable to achieve such keypoint pixel spacing and/or distribution without explicitly requiring keypoint pixels to be identified in any particular portion of the input image (e.g., dividing the input image into a grid, and requiring each cell of the grid to include one keypoint pixel), since such keypoint pixel detection in the given portion might be more likely to result in a false positive detection.

Accordingly, after selecting the keypoint pixel from the convolution image, the convoluting image may be updated by assigning a neutral value to the keypoint pixel and to a plurality of neighboring pixels around the keypoint pixel. Specifically, the neighboring pixels may be located at predetermined pixel coordinates relative to the keypoint pixel, and may thus form a predetermined shape (e.g., square, rectangle, circular shape, etc.) that includes (e.g., is centered on) the keypoint pixel. The neutral value may be excluded from the detection value range. Thus, pixels of the updated convolution image that have the neutral value might not be selectable as keypoint pixels in subsequent iterations, thus providing at least a minimum spacing between the keypoint pixel and any subsequently detected keypoint pixels. This minimum spacing between keypoint pixels may prevent formation of dense clusters of keypoint pixels and may allow keypoint pixels to be uniformly distributed across at least part of the input image.

The keypoint pixel detector may be configured to generate output data that represents the keypoint pixels detected within the input image. For example, the output data may represent each respective keypoint pixel using a corresponding vector that includes values representing (i) coordinates of the respective keypoint pixel and (ii) visual contents of an image patch surrounding the respective keypoint pixel. The corresponding vector may be referred to as an embedding vector and/or a feature vector, among other possibilities. When keypoint pixels are clustered and/or unevenly distributed, the corresponding vectors may represent redundant information, and thus might be less useful in representing the input image than keypoint pixels that are separated from one another by at least the minimum spacing and/or are uniformly distributed throughout the input image.

For example, when the input image represents a fingerprint, the output data may represent a plurality of fingerprint minutia. The output data may thus include or be used to determine fingerprint enrollment data indicating properties of a fingerprint that is authorized to unlock a computing device, or a verification data indicating properties of a fingerprint used in an attempt to unlock the computing device. Keypoint pixels determined in the manner described herein may reduce the incidence of false positive and false negative fingerprint-based authentication results, thus improving device security and user experience.

In some implementation, a signal strength and/or a signal-to-noise ratio of the convolution image may be improved by (i) scaling pixel values of the input image to a rescaled range that extends from a predetermined negative value to a predetermined positive value and (ii) using a kernel that includes a region of positive values and a region of negative values. Thus, instances of the predetermined image feature may be detected based on (i) a first positively valued output of convolving the positive values of the kernel with positive values representing the predetermined image feature in the input image (ii) and a second positively valued output of convolving the negative values of the kernel with negative values representing a surrounding of the predetermined image feature in the input image. That is, instances of the predetermined image feature may be detected based on pixel values of the predetermined image feature itself, as well as pixel values of its surroundings/context, rather than only based on the pixel values of the predetermined image feature itself.

### II. Example Computing Devices and Systems

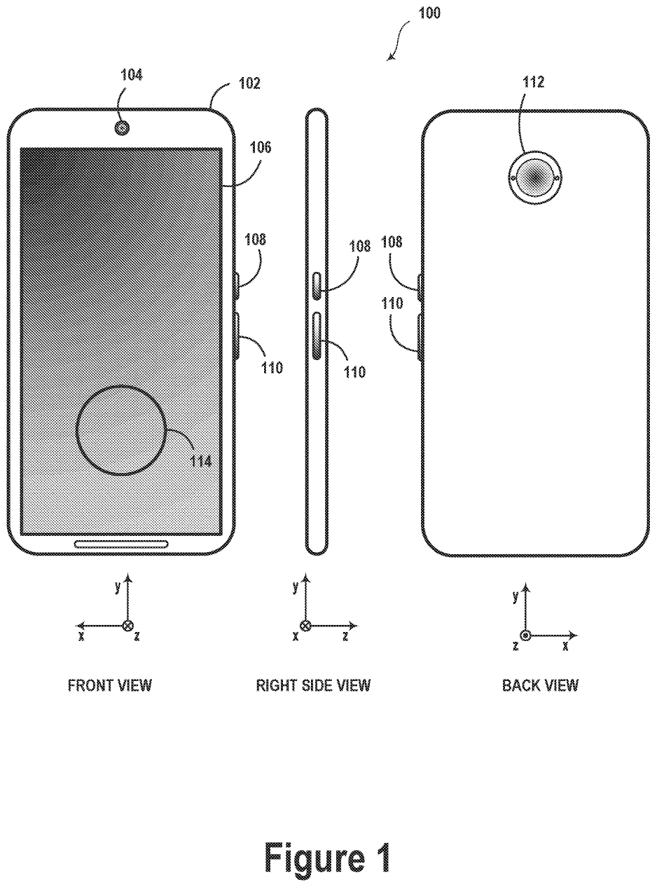

FIG. 1 illustrates an example computing device 100. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and rear-facing camera 112.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

Computing device 100 may include in-screen fingerprint scanner 114 configured to generate an image of a fingerprint of a finger placed in the corresponding region of display 106. In-screen fingerprint scanner 114 may be implemented using optical components (e.g., a camera and illuminator), capacitive components, and/or ultrasonic components, among other possibilities. For example, in-screen fingerprint scanner 114 may include a plurality of sensors (e.g., optical, capacitive, ultrasonic, etc.) arranged in an array and configured to generate sensor data that can be represented as a two-dimensional or three-dimensional tensor, and thus treated as a grayscale and/or color image. In some implementations, in-screen fingerprint scanner 114 may be positioned in a different region of display 106, may span a smaller or larger portion of display 106, and/or may be positioned on a backside of computing device 100.

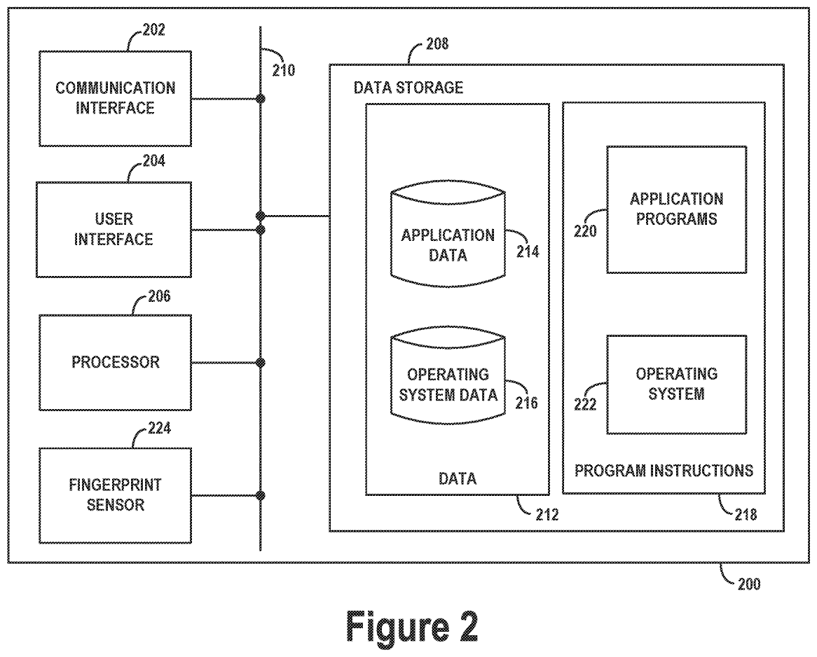

FIG. 2 is a simplified block diagram showing some of the components of an example computing system 200. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and fingerprint sensor 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors-e.g., microprocessors-and/or one or more special purpose processors-e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

In one example, fingerprint sensor 224 may be an optical fingerprint sensor that includes an illuminator and/or one or more cameras configured to capture an image of a fingerprint. In another example, fingerprint sensor 224 may be a capacitive fingerprint sensor that includes an array of capacitors configured to measure variations in capacitance across an area of the fingerprint. The variation in capacitance may be representable as an image, with the area of the image corresponding to the area of the fingerprint, and pixel values of the image representing the measured capacitance. In a further example, fingerprint sensor 224 may be an ultrasonic fingerprint sensor that includes an array of ultrasonic transducers configured to measure variations in distance between the transducers and the fingerprint across the area of the fingerprint. The variation in distance may be representable as an image, with the area of the image corresponding to the area of the fingerprint, and the pixel values thereof representing the measured distance. Fingerprint sensor 224 may be controlled at least in part by software executed by processor 206.

### III. Example Keypoint Detection System

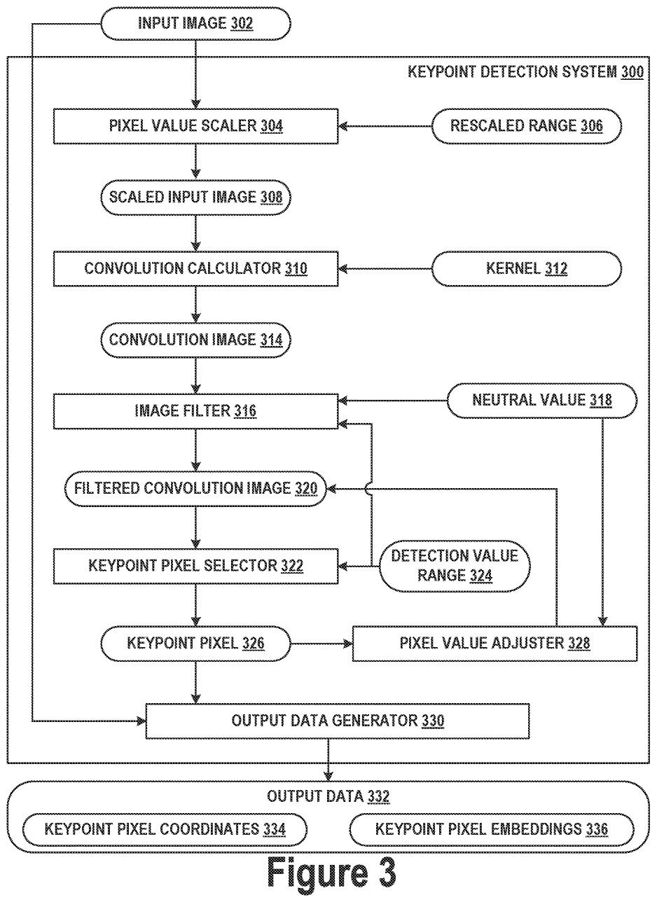

FIG. 3 illustrates an example keypoint detection system. Specifically, keypoint detection system 300 may include pixel value scaler 304, convolution calculator 310, image filter 316, keypoint pixel selector 322, pixel value adjuster 328, and output data generator 330. Keypoint detection system 300 may be configured to generate output data 332 based on input image 302. Output data 332 may represent one or more instances of at least one predetermined image feature detected within input image 302 by keypoint detection system 300 and represented using keypoint pixels.

Input image 302 may include a plurality of pixels, and may represent a plurality of different scenes, objects, and/or visual features. Input image 302 may be a grayscale image represented as an H×W×1 tensor, or a color image represented as, for example, an H×W×3 tensor. In one example, input image 302 may represent a human fingerprint, and may thus be used to facilitate a fingerprint-based use authentication process, which may include fingerprint enrollment (e.g., definition of a fingerprint that is authorized to unlock a computing device) and fingerprint verification (e.g., determination whether a fingerprint matches a previously enrolled fingerprint).

Keypoint detection system 300 may be configured to detect, within input image 302, one or more instances of at least one predetermined image feature. For example, when input image 302 represents the human fingerprint, the predetermined image feature may include fingerprint minutiae, such as a ridge(s) end and/or a valley end(s). In other applications of keypoint detection system 300, the predetermined image feature may include other shapes and/or visual features. In general, the predetermined image feature may include any visual pattern as defined by the number, spatial arrangement, and pixel values of a plurality of pixels.

Pixel value scaler 304 may be configured to generate scaled input image 308 based on input image 302 and rescaled range 306. Specifically, pixel value scaler 304 may be configured to scale the pixel values of input image 302, rather than a size and/or resolution of input image 302. Thus, a number and spatial arrangement of pixels of scaled input image 308 may be equal to a number and spatial arrangement of pixels of input image 302. Scaling input image 302 to rescaled range 306 may improve the detectability of instances of the predetermined image feature. That is, it may be easier to accurately detect instances of the predetermined image feature in scaled input image 308 than in input image 302, as explained in more detail below.

Pixel values of input image 302 may be represented using an initial range that extends from a minimum initial pixel value (e.g., 0) to a maximum initial pixel value (e.g., 255). Rescaled range 306 may extend from a predetermined negative pixel value (e.g., −127) to a predetermined positive pixel value (e.g., 128). Rescaled range 306 may be a modifiable parameter of keypoint detection system 300. In one example, rescaled range 306 may be selected such that a midpoint thereof is a zero pixel value. In another example, rescaled range 306 may be selected such that the midpoint thereof substantially and/or approximately maps to a middle gray (i.e., 18% gray) pixel value as represented in input image 302. Thus, in such cases, the mapping performed by pixel value scaler 304 may additionally apply a white balancing effect to input image 302.

Pixel value scaler 304 may be configured to linearly map the pixel values of input image 302 to rescaled range 306. Thus, the minimum initial pixel value of the initial range may be mapped to the predetermined negative value of rescaled range 306, the maximum initial pixel value of the initial range may be mapped to the predetermined positive value of rescaled range 306, and a midpoint of the initial range may be mapped to a midpoint of rescaled range 306. In cases where a number of elements in the initial range (e.g., [0, 255]) is equal to a number of elements in rescaled range 306 (e.g., [−127, 128]), pixel value scaler 304 may determine scaled input image 308 by subtracting a range offset value (e.g., 127) from the corresponding pixel value of each pixel of input image 302. In cases where a number of elements in the initial range is different from a number of elements in rescaled range 306, pixel value scaler 304 may be configured to additionally multiply and/or divide the pixel values of input image 302 by a range scaling factor to perform the mapping.

Convolution calculator 310 may be configured to generate convolution image 314 based on scaled input image 308 and kernel 312. Specifically, convolution calculator 310 may be configured to convolve scaled input image 308 with kernel 312.

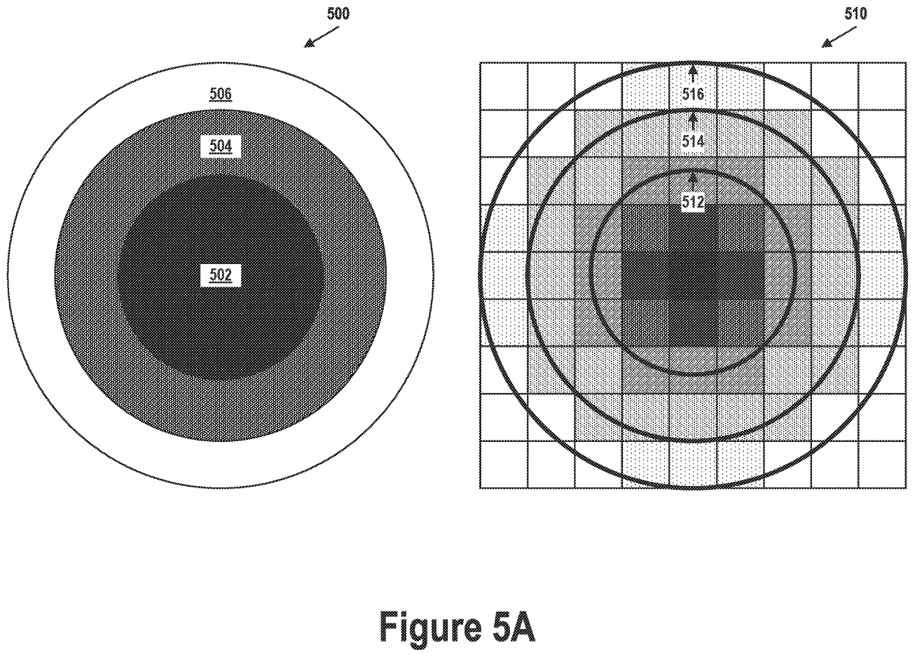

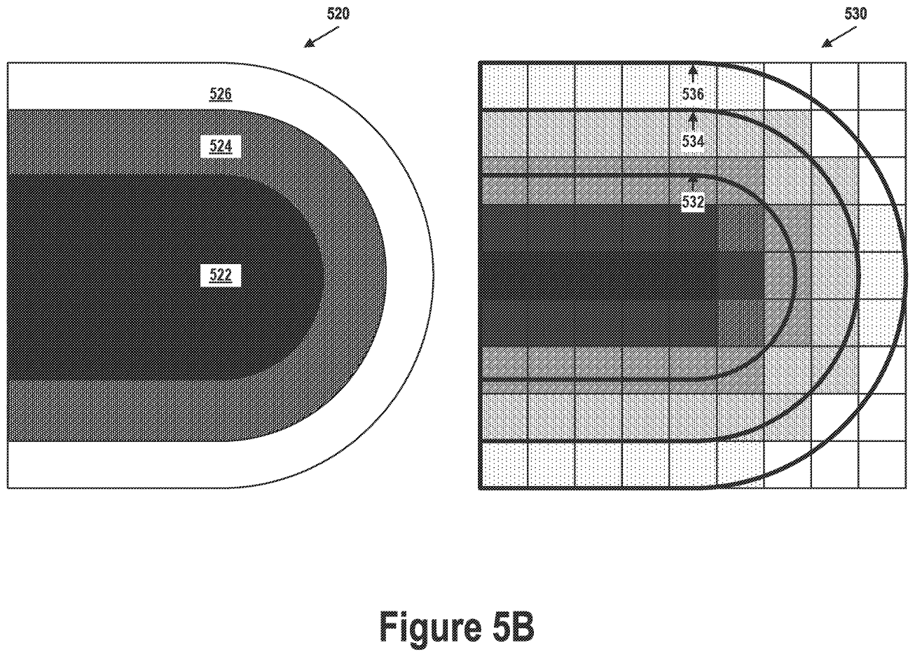

Kernel 312 may correspond to and/or represent at least part of the predetermined image feature to be detected within scaled input image 308. Specifically, kernel 312 may include a plurality of kernel pixels, each of which may be associated with a corresponding real pixel value, an imaginary pixel value, or a combination thereof (i.e., a corresponding complex pixel value). The number, spatial arrangement, and/or values of the plurality of kernel pixels may match and/or correspond to an expected representation of the predetermined image feature within scaled input image 308. A range of values of the kernel pixels of kernel 312 may correspond to rescaled range 306. For example, the kernel pixels of kernel 312 may include both positive values and negative values. In some cases, kernel 312 may include a plurality of different kernels, each representing a different corresponding predetermined image feature to be detected within input image 302. Thus, the operations discussed herein may be repeated for each predetermined image feature to be detected. Examples of kernel 312 are illustrated in and discussed with respect to FIGS. 5A and 5B.

In some implementations, pixel value scaler 304 and/or the operations performed thereby may be omitted. Accordingly, convolution calculator 310 may instead generate convolution image 314 based on input image 302 and kernel 312. The range of values of kernel 312 may thus be selected to match and/or correspond to the initial range of pixel values of input image 302, rather than to rescaled range 306. For example, the kernel pixels of kernel 312 may include positive values, but might not include any negative values.

Image filter 316 may be configured to generate filtered convolution image 320 based on convolution image 314, neutral value 318, and detection value range 324. Detection value range 324 may represent a range of values of convolution image 314 that could and/or are likely to represent the predetermined image feature. Neutral value 318 may be a particular value that indicates that a corresponding pixel of convolution image 314 and/or filtered convolution image 320 does not and/or is not likely to represent the predetermined image feature. Accordingly, neutral value 318 may be excluded from detection value range 324. In some implementations, neutral value 318 may include a plurality of values, each of which is excluded from detection value range 324. Neutral value 318 may be considered “neutral” in that it is reserved for designating that a pixel does not and/or cannot represent an instance of the predetermined image feature, and/or represents or is near a lower end of a value range of convolution image 314. Neutral value 318 may alternatively be referred to as a non-detection value.

Image filter 316 may be configured to generate filtered convolution image 320 by assigning neutral value 318 to pixels of convolution image 314 that have corresponding values outside of detection value range 324. Using filtered convolution image 320 may facilitate the process of identifying instances of the predetermined image feature in input image 302. In some implementations, each of input image 302, scaled input image 308, convolution image 314, and/or filtered convolution image 320 may have a same resolution.

Keypoint pixel selector 322 may be configured to select keypoint pixel 326 based on filtered convolution image 320 and detection value range 324. Keypoint pixel 326 may represent a location within convolution image 314 (and thus within input image 302) of an instance of the predetermined image feature that kernel 312 is configured to detect. Keypoint pixel 326 may thus represent a salient location within input image 302. Keypoint pixel 326 may represent a particular portion, part, and/or aspect of the predetermined image feature (e.g., a geometric center of the predetermined image feature or a center of mass of the predetermined image feature, among other possibilities), since the predetermined image feature may span a plurality of pixels.

Specifically, keypoint pixel selector 322 may be configured to select, from filtered convolution image 320, keypoint pixel 326 having a corresponding value that is within detection value range 324. For example, keypoint pixel 326 may be selected based on being the largest valued pixel in detection value range 324 or based on being the smallest valued pixel in detection value range 324, depending on whether large or small values are used to represent the predetermined image feature in filtered convolution image 320.

In one example, the predetermined image feature may be represented in filtered convolution image 320 using positive values, with the likelihood that a given pixel represents an instance of the predetermined image feature being proportional to a corresponding value of the given pixel (i.e., higher pixel values are more likely to be selected as keypoint pixels). For example, convolution image 314 may have a range [0, 255], neutral value 318 may be equal to 0, and detection value range may be equal to [200, 255]. Detection value range 324 may thus extend from a threshold convolution value (e.g., 200 in the provided example) to a maximum pixel value (e.g., 255 in the example provided). Accordingly, filtered convolution image 320 may include pixels that have a value of zero or a value in the range [200, 255]. Keypoint pixel selector 322 may thus be configured to select, as keypoint pixel 326, a pixel of filtered convolution image 320 that has a highest pixel value.

In another example, the predetermined image feature may be represented in filtered convolution image 320 using positive values, with the likelihood that a given pixel represents an instance of the predetermined image feature being inversely proportional to a corresponding value of the given pixel (i.e., lower pixel values are more likely to be selected as keypoint pixels). That is, the “color” of the predetermined image features in filtered convolution image 320 may be inverted relative to the preceding example. For example, convolution image 314 may have a range [0, 255], neutral value 318 may be equal to 255, and detection value range may be equal to [0, 55]. Detection value range 324 may thus extend from a minimum pixel value (e.g., 0 in the provided example) to an inverted threshold convolution value (e.g., 55 in the example provided). Accordingly, filtered convolution image 320 may include pixels that have a value of 255 or a value in the range [0, 55]. Keypoint pixel selector 322 may thus be configured to select, as keypoint pixel 326, a pixel of filtered convolution image 320 that has a lowest pixel value.

When keypoint pixel selector 322 operates on filtered convolution image 320, keypoint pixel selector 322 may select keypoint pixel 326 by selecting the highest valued or lowest valued pixel, depending on the color scheme of filtered convolution image 320, without explicitly determining whether the corresponding value of keypoint pixel 326 falls within detection value range 324. That is, when image filter 316 is used to remove, from convolution image 314, values outside of detection value range 324, selection of the highest-valued or lowest-valued pixel, depending on the color scheme of filtered convolution image 320, may inherently involve a selection of keypoint pixel 326 having a value within detection value range. Thus, filtered convolution image 320 may facilitate the process of identifying instances of the predetermined image feature in input image 302.

In some implementations, image filter 316 may be omitted, and keypoint pixel selector 322 may instead select keypoint pixel 326 based on convolution image 314. Accordingly, keypoint pixel selector 322 may select keypoint pixel 326 by (i) selecting the highest-valued pixel that exceeds the threshold convolution value of detection value range 324 or (ii) selecting lowest-valued pixel that is less than the inverted threshold convolution value of detection value range 324, depending on the color scheme of filtered convolution image 320. That is, keypoint pixel selector 322 may be configured to explicitly determine whether the corresponding value of keypoint pixel 326 falls within detection value range 324.

Pixel value adjuster 328 may be configured to update filtered convolution image 320 based on keypoint pixel 326. Specifically, keypoint pixel selector 322 may operate iteratively to select a plurality of keypoint pixels from filtered convolution image 320. In order to indicate that a given pixel has already been selected as a keypoint pixel, pixel value adjuster 328 may be configured to update filtered convolution image 320 by assigning neutral value 318 to keypoint pixel 326. Since neutral value 318 is excluded from detection value range 324, assignment of neutral value 318 to keypoint pixel 326 may preclude keypoint pixel 326 from being reselected by a subsequent iteration of keypoint pixel selector 322, thus allowing additional different keypoint pixels to be selected as keypoint pixels based on filtered convolution image 320 as updated.

Additionally, in order to allow keypoint detection system 300 to select keypoint pixels that are separated from one another by at least a minimum pixel distance, pixel value adjuster 328 may also be configured to update filtered convolution image 320 by assigning neutral value 318 to a plurality of neighboring pixels positioned at predetermined coordinates relative to keypoint pixel 326. Since neutral value 318 is excluded from detection value range 324, assignment of neutral value 318 to the plurality of neighboring pixels may preclude the plurality of neighboring pixels from being selected by a subsequent iteration of keypoint pixel selector 322, thus allowing one or more subsequent keypoint pixels to be separated from keypoint pixel 326 by at least a minimum spacing indicated by the predetermined coordinates.

The predetermined coordinates may define a predetermined shape around keypoint pixel 326, such as a square, rectangle, an approximate circle, and/or an irregular shape. For example, when the predetermined coordinates form an approximate circle centered on keypoint pixel 326, a radius (measured in pixels) of the approximate circle may indicate a minimum spacing between keypoint pixel 326 and any subsequently determined keypoint pixel. When the predetermined coordinates form a rectangle centered on keypoint pixel 326, a minimum horizontal spacing between keypoint pixel 326 and any subsequently determined keypoint pixel may be based on a width of the rectangular area, and a minimum vertical spacing between keypoint pixel 326 and any subsequently determined keypoint pixel may be based on a height of the rectangular area.

A maximum number of keypoint pixels detectable within filtered convolution image 320 may be based on a number of the plurality of neighboring pixels. For example, when filtered convolution image 320 includes P pixels, and the plurality of neighboring pixels include N pixels, a maximum number of detectable keypoint pixels may be expressed as P/(N+1), since each keypoint pixel detection causes pixel value adjuster 328 to set up to N+1 pixels to neutral value 318.

Output data generator 330 may be configured to generate output data 332 based on keypoint pixel 326 and, in some cases, based on input image 302. Output data 332 may include keypoint pixel coordinates 334 and keypoint pixel embeddings 336. Keypoint pixel coordinates 334 may include, for each respective keypoint pixel detected within input image 302, corresponding coordinates of the respective keypoint within input image 302. Keypoint pixel embeddings 336 may include, for each respective keypoint pixel detected within input image 302, a corresponding latent and/or compressed representation of the visual content of an image patch in input image 302, wherein the image patch includes the respective keypoint pixel. Keypoint pixel coordinates 334 and keypoint pixel embeddings 336 may be represented as vectors, each of which is associated with and represents a corresponding detected keypoint pixel.

When output data 332 is generated based on an input image that represents an enrollment fingerprint that is being defined as authorized to unlock a computing device, output data 332 may be used to define fingerprint enrollment data. When output data 332 is generated based on an input image that represents a verification fingerprint that is being used to attempt to unlock a computing device, output data 332 may be used to define fingerprint verification data. As part of the attempt to unlock the computing device, the fingerprint verification data may be compared to the fingerprint enrollment data to determine a match score. For example, the match score may be based on (i) how closely keypoint pixel coordinates 334 of the fingerprint verification data match keypoint pixel coordinates 334 of the fingerprint enrollment data and/or (ii) how closely keypoint pixel embeddings 336 of the fingerprint verification data match keypoint pixel embeddings 336 of the fingerprint enrollment data. A determination of whether to unlock the computing device may be based on the match score.

### IV. Example Images

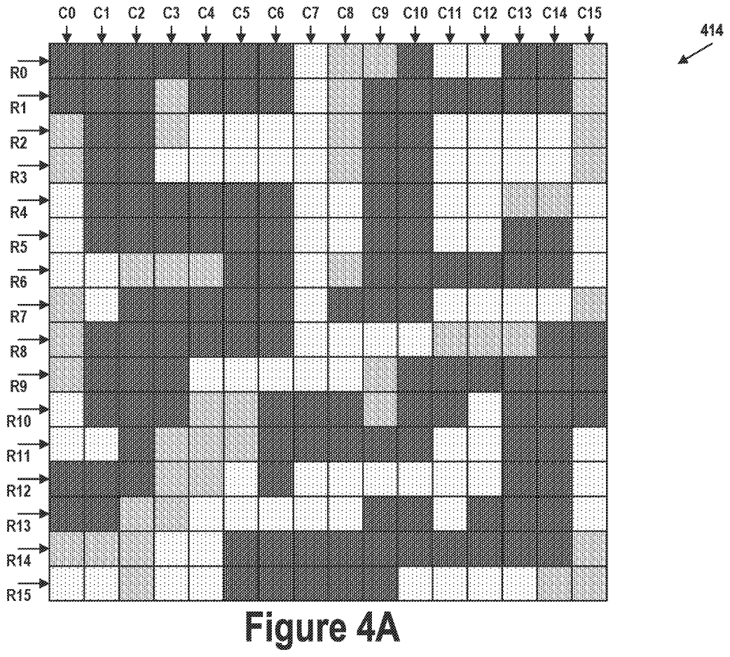

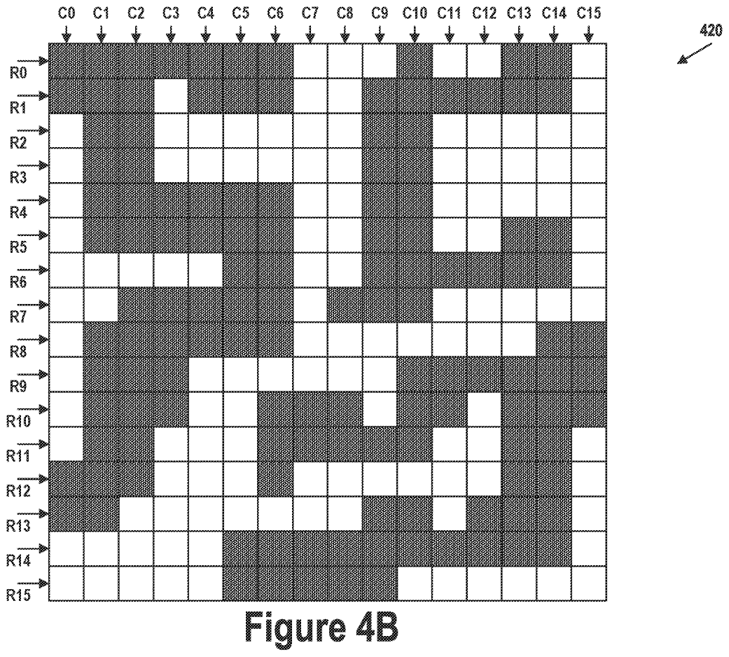

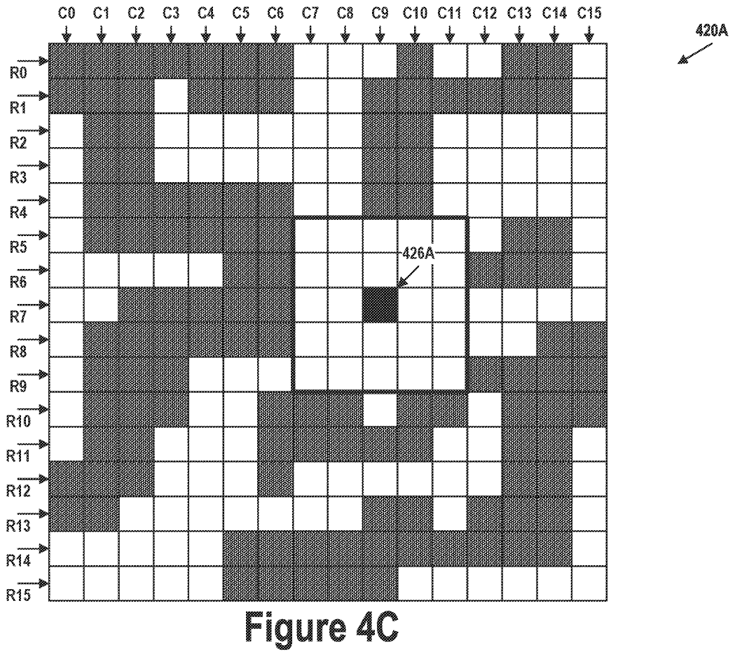

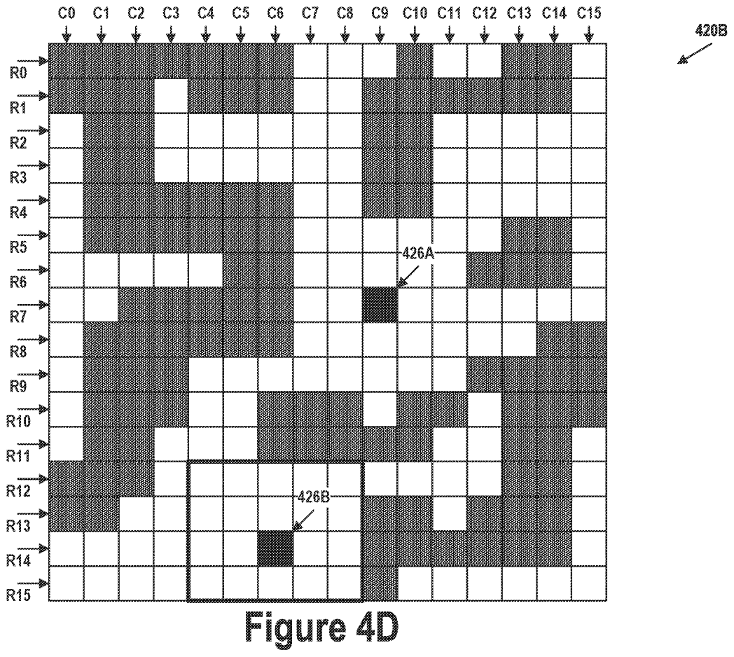

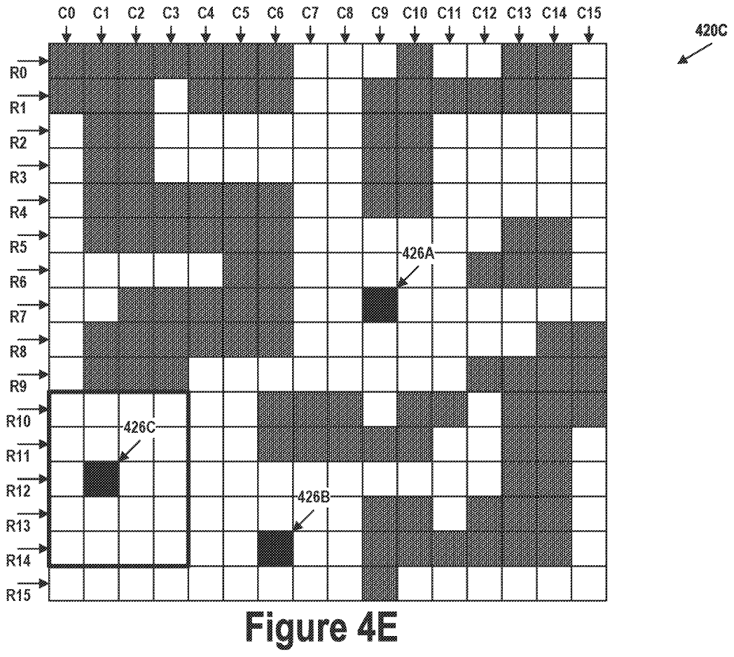

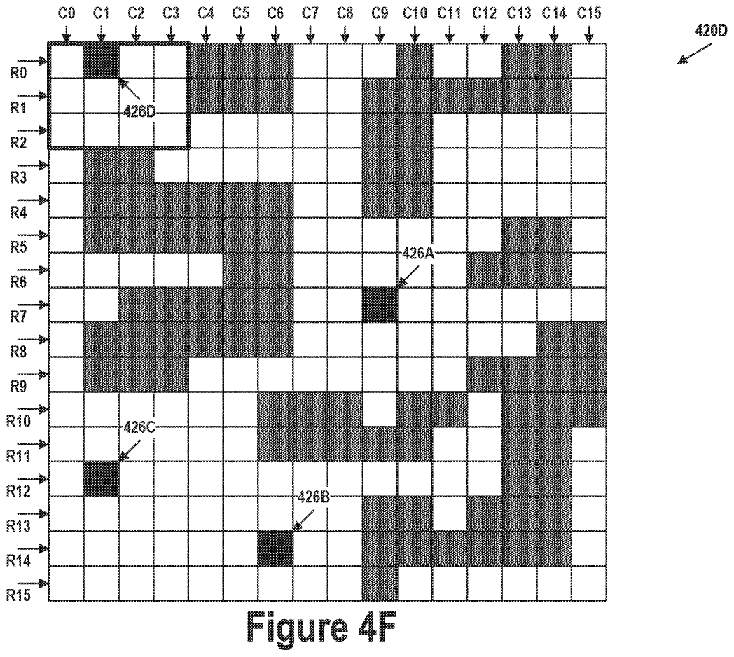

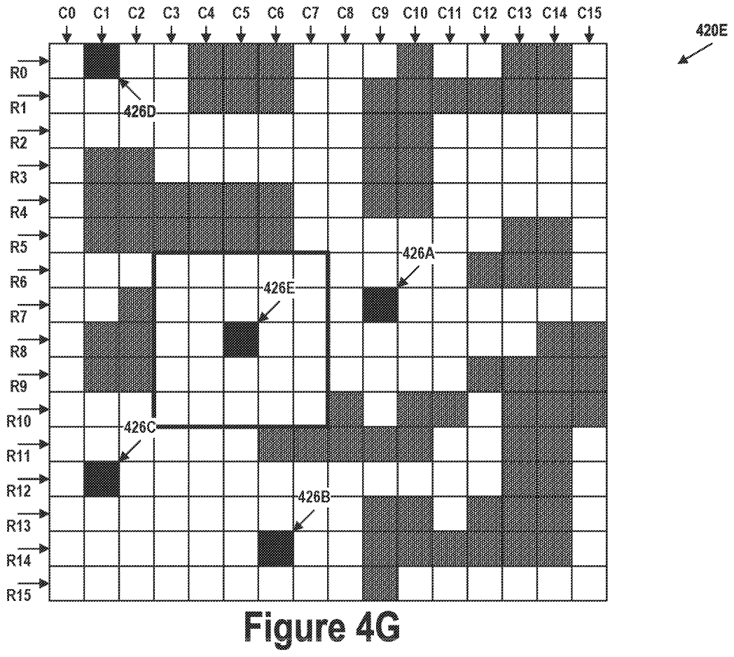

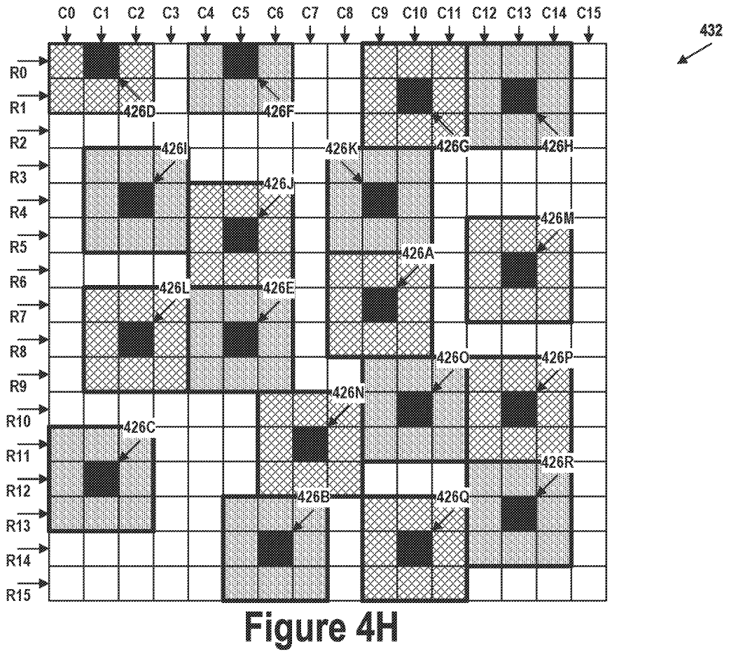

FIG. 4A provides a graphical representation of convolution image 414, which may be an example of convolution image 314. Convolution image 414 includes a plurality of pixels arranged into 16 rows R0 through R15 (i.e., R0-R15) and 16 columns C0 through C15 (i.e., C0-C15). Each respective pixel of the plurality of pixels of convolution image 414 is associated with a corresponding convolution pixel value. Convolution image 414 may be a result of convolving kernel 312 with an input image that represents, for example, a fingerprint. Thus, each respective pixel of the plurality of pixels of convolution image 414 may also be associated with a corresponding pixel of the input image.

The values of the plurality of pixels are visually illustrated using three different visual patterns. A first plurality of pixels having values in the range [0, 99] is indicated using a first visual pattern, as shown for example by the pixel at R4, C0. A second plurality of pixels having values in the range [100, 199] is indicated using a second visual pattern, as shown for example by the pixel at R7, C0. A third plurality of pixels having values in the range [200, 255] is indicated using a third visual pattern, as shown for example by the pixel at R0, C0.

In the context of the example of FIG. 4A, the likelihood of a given pixel representing the predetermined image feature is assumed, for the sake of the example, to be proportional to a corresponding value of the given pixel. Thus, pixels of the third plurality of pixels are more likely to represent the predetermine image feature than pixels of the second plurality of pixels, and pixels of the second plurality of pixels are more likely to represent the predetermine image feature than pixels of the first plurality of pixels. The predetermined image feature may represent a fingerprint ridge end, and thus the third plurality of pixels may represent likely locations of ridge ends, the first plurality of pixels may represent likely locations of valley ends, and the second plurality of pixels may represent likely locations of boundaries between ridges and valleys.

FIG. 4B provides a graphical representation of filtered convolution image 420, which may be an example of filtered convolution image 320. In the context of the example of FIG. 4B, detection value range 324 is assumed, for the sake of the example, to be [200, 255], and neutral value 318 is assumed to be zero. Accordingly, filtered convolution image 420 has a same resolution as convolution image 414, and all pixels of convolution image 414 with values in the range [0, 199] (i.e., the first and second pluralities of pixels) have had their values adjusted to zero. That is, filtered convolution image 420 represents the third plurality of pixels (corresponding to detection value range 324) of convolution image 414 using the same non-zero values as found in convolution image 414, and represents all other pixels as having a value of zero.

A keypoint pixel may be selected from filtered convolution image 420 by selecting a highest valued pixel, which indicates a highest likelihood that the predetermined image feature was identified at this pixel in input image 302 using kernel 312. FIG. 4C illustrates keypoint pixel 426A selected based on being a highest valued pixel of the third plurality of pixels of filtered convolution image 420. Output data generator 330 may store the coordinates of keypoint pixel 426A and any subsequently determined keypoint pixels to be used in generating output data 332 that represents keypoint pixel 426A and the subsequent keypoint pixels.

To prevent keypoint pixel 426A from being re-detected by subsequent iterations of keypoint pixel selector 322, a value of keypoint pixel 426A may be adjusted to zero. To allow for a minimum spacing between keypoint pixel 426A and subsequent keypoint pixels detected by the subsequent iterations of keypoint pixel selector 322, respective values of neighboring pixels located in a square centered on keypoint pixel 426A may also be adjusted to zero. Specifically, the neighboring pixels may include all pixels with coordinates that are within two pixels of the coordinates (R7, C9) of keypoint pixel 426A along the horizontal and vertical directions. Thus, the neighboring pixels may include pixels located in the square having corners at pixel coordinates (R5, C7), (R5, C11), (R9, C7), and (R9, C11). Adjusting the respective values of keypoint pixel 426A and the neighboring pixels thereof to zero may result in generation of updated filtered convolution image 420A from which one or more subsequent keypoint pixels may be selected.

A second keypoint pixel may be selected from updated filtered convolution image 420A by selecting a highest valued pixel. FIG. 4D illustrates keypoint pixel 426B selected based on being a highest valued pixel of the pixels of updated filtered convolution image 420A. A respective value of each of keypoint pixel 426B and neighboring pixels located within two pixels of keypoint pixel 426B may be adjusted to zero. Thus, the neighboring pixels of keypoint pixel 426B may include pixels located in a 4×5 rectangle having corners at pixel coordinates (R12, C4), (R12, C8), (R15, C4), and (R15, C8).

In the case of keypoint pixel 426B, the neighboring pixels may form a 4×5 rectangle, rather than a 5×5 square as was the case with keypoint pixel 426A, due to keypoint pixel 426B being located one pixel away from a bottom end of updated filtered convolution image 420A. Other keypoint pixels located within less than two pixels of a left end, right end, top end, and/or bottom end of the updated filtered convolution image may similarly be associated with neighboring pixels that form a rectangle smaller than the 5×5 square. Adjusting the respective values of keypoint pixel 426B and the neighboring pixels thereof to zero may resulting in generation of updated filtered convolution image 420B from which one or more subsequent keypoint pixels may be selected.

A third keypoint pixel may be selected from updated filtered convolution image 420B by selecting a highest valued pixel. FIG. 4E illustrates keypoint pixel 426C selected based on being a highest valued pixel of the pixels of updated filtered convolution image 420B. A respective value of each of keypoint pixel 426C and neighboring pixels located within two pixels of keypoint pixel 426C may be adjusted to zero. Thus, the neighboring pixels of keypoint pixel 426C may include pixels located in a 5×4 rectangle having corners at pixel coordinates (R10, C0), (R10, C3), (R14, C0), and (R14, C3). Adjusting the respective values of keypoint pixel 426C and the neighboring pixels thereof to zero may result in generation of updated filtered convolution image 420C from which one or more subsequent keypoint pixels may be selected.

A fourth keypoint pixel may be selected from updated filtered convolution image 420C by selecting a highest valued pixel. FIG. 4F illustrates keypoint pixel 426D selected based on being a highest valued pixel of the pixels of updated filtered convolution image 420C. A respective value of each of keypoint pixel 426D and neighboring pixels located within two pixels of keypoint pixel 426D may be adjusted to zero. Thus, the neighboring pixels of keypoint pixel 426D may include pixels located in a 3×4 rectangle having corners at pixel coordinates (R0, C0), (R0, C3), (R2, C0), and (R2, C3). Adjusting the respective values of keypoint pixel 426D and the neighboring pixels thereof to zero may result in generation of updated filtered convolution image 420D from which one or more subsequent keypoint pixels may be selected.

A fifth keypoint pixel may be selected from updated filtered convolution image 420D by selecting a highest valued pixel. FIG. 4G illustrates keypoint pixel 426E selected based on being a highest valued pixel of the pixels of updated filtered convolution image 420D. A respective value of each of keypoint pixel 426E and neighboring pixels located within two pixels of keypoint pixel 426E may be adjusted to zero. Thus, the neighboring pixels of keypoint pixel 426D may include pixels located in a 5×5 square having corners at pixel coordinates (R6, C3), (R6, C7), (R10, C3), and (R10, C7). Adjusting the respective values of keypoint pixel 426E and the neighboring pixels thereof to zero may result in generation of updated filtered convolution image 420E from which one or more subsequent keypoint pixels may be selected.

Such iterative selection of keypoint pixels may continue until all pixels of the updated filtered convolution image have been set to zero. FIG. 4H provides a visual representation of output data 432, which may be an example of output data 332. Output data 432 represents keypoint pixels 426A, 426B, 426C, 426D, 426E, 426F, 426G, 426H, 4261, 426J, 426K, 426L, 426M, 426N, 4260, 426P, 426Q, and 426R (i.e., keypoint pixels 426A-426R) detected based on filtered convolution image 420 and iteratively updated versions thereof.

Output data 432 illustrates each of keypoint pixels 426A-426R surrounded by a one pixel border forming up to a 3×3 square centered on each respective keypoint pixel. The 3×3 square (or smaller rectangle, if near an image border, as in the case of keypoint pixels 426D and 426F) of a respective keypoint pixel defines an area of the input image on which a vector associated with the respective keypoint pixel (and representing the corresponding instance of the predetermined feature) may be based. This area may be referred to as a receptive area and/or a receptive field, among other possibilities. The vector associated with the respective keypoint may include (i) pixel coordinates of the respective keypoint within the input image and (ii) one or more values representing an output of a transform, algorithm, model, and/or other mathematical operator applied to the receptive area of the input image to generate a compressed representation of the visual contents of the receptive area. The vector associated with the respective keypoint may be referred to as a keypoint vector, an embedding vector, and/or a feature vector, among other possibilities.

Since the receptive area associated with a respective keypoint is defined using a one pixel border surrounding the respective pixel, and the minimum spacing between adjacent keypoint pixels is two pixel, the receptive areas of keypoint pixels 426A-426R are non-overlapping (i.e., mutually exclusive). That is, in general, when the receptive area of the respective keypoint is defined by an N pixel border surrounding the respective pixel (resulting in a (2N+1)×(2N+1) square centered on the respective keypoint pixel), and the minimum spacing between adjacent keypoint pixels is 2N pixels (resulting from adjusting to zero all neighboring pixels within a (4N+1)×(4N+1) square centered on the respective keypoint pixel), the receptive areas of detected keypoint pixels will be non-overlapping. As a result, the vectors associated with the detected keypoint pixels may be unique and/or non-redundant.

Uniqueness and/or non-redundancy of the vectors associated with the detected keypoint pixels may facilitate matching the detected keypoint pixels to reference keypoint pixels detected in a reference input image and represented using reference vectors (e.g., matching fingerprint verification data to fingerprint enrollment data). Specifically, the vectors may represent a larger portion of the input image than an equal number of vectors determined without adhering to the minimum spacing among keypoint pixels. Similarly, the reference vectors (determined in the same or similar manner) may represent a larger portion of the reference input image than an equal number of reference vectors determined without adhering to the minimum spacing among reference keypoint pixels. Thus, when comparing the vectors representing the keypoint pixels detected within the input image to the reference vectors representing the reference keypoint pixels detected in the reference input image, the visual content of a larger portion of these images may be considered, resulting in a more accurate and/or thorough comparison.

For example, the input image on which convolution image 414 is based may represent a fingerprint to be used as part of an authentication attempt to, for example, unlock a computing device and/or access an aspect thereof. Thus, output data 432 may comprise and/or form part of fingerprint verification data. Keypoint pixels 426A-426R may represent a first set of fingerprint minutiae detected within the input image, each of which may be represented using a corresponding verification vector. The reference keypoint pixels may be represented by fingerprint enrollment data that represents, using enrollment vectors, attributes of a second set of fingerprint minutiae of a fingerprint that is authorized to unlock a computing device. The second set of fingerprint minutiae may be detected within the reference input image representing the authorized fingerprint using the same or similar process as used for detecting the first set of fingerprint minutiae, and may be represented using enrollment vectors.

Thus, the process of matching the verification vectors to the enrollment vectors may, due to the uniqueness and/or non-redundancy of these vectors, result in a more accurate, thorough, reliable, and/or consistent comparison. As a result, fewer false positive and false negative authentication results may be experienced, thus improving device security and user experience.

In some implementations, convolution image 414 may additionally or alternatively be used to detect keypoint pixels that represent valley ends (rather than or in addition to ridge ends). Specifically, valley ends may be detected by selecting lowest valued pixels within a valley-specific detection value range, which may represent an inversion of the detected value range for a ridge end. In the context of the example of FIG. 4A, the valley-specific detection value range may be [0, 55], and neutral value 318 may be 255. Thus, a plurality of keypoint pixels representing valley ends may be detected using the same procedure as discussed above, but using the valley-specific detection value range and neutral value. Valley end keypoint pixels may be represented in output data 332 in the same manner as ridge end keypoint pixels.

### V. Example Convolution Kernels

FIG. 5A illustrates convolution kernel 500 that is rotationally symmetric, and provides a first example of kernel 312. Specifically, convolution kernel 500 includes a first region 502, a second region 504, and a third region 506. First region 502 may be a circle, second region 504 may be a ring surrounding first region 502, and third region 506 may be a ring surrounding second region 504. Thus, convolution kernel 500 may be configured to detect circles and/or circular image features within an input image.

A discretized version of convolution kernel 500 is represented by kernel image 510, which includes a plurality of kernel pixels having respective values that approximate the values of regions 502, 504, and 506. Specifically, kernel pixels within circle 512 approximate first region 502, kernel pixels between circle 512 and 514 approximate second region 504, and kernel pixels between circle 514 and 516 approximate third region 506.

The values of regions 502, 504, and 506 (represented by corresponding kernel pixels of kernel image 510) may be configured to improve detection of circles and/or circular features within input images. Specifically, first region 502 may include a plurality of positive values that represent the circular image feature, second region 504 may include a plurality of neutral values that represent a boundary between the circular image feature and surroundings thereof, and third region 506 may include a plurality of negative values that represent the surroundings of the circular image feature. For example, in the context of fingerprint minutiae detection, first region 502 may correspond to a ridge end, third region 506 may correspond to a valley surrounding the ridge end, and second region 504 may correspond to the ridge-valley boundary and/or transition. A detected keypoint pixel may thus represent a center of the ridge end.

When the input image is scaled to rescaled range 306, which includes both positive values representing the circular feature and negative values representing the surroundings thereof, the output of convolving the input image with convolution kernel 500 will be based on a sum of (i) a first product of the positive values of first region 502 and positive values of pixels in the input image that represent the circular image feature, (ii) a second product of the neutral values of second region 504 and the values of pixels in the input image that represent the boundary/transition between the circular image feature and the surroundings thereof, and (iii) a third product of the negative values of third region 506 and negative values of pixels in the input image that represent the surroundings of the circular image feature in the input image.

The neutral values of region 504 and the values of pixels in the input image that represent the boundary/transition may be approximately evenly distributed about zero. Thus, when convolution kernel 500 is aligned with a portion of the input image that represents the circular image feature, a magnitude of the second product may be relatively small compared to the first product and/or the third product. Each of the first product and the third product may be positively valued. Accordingly, both the circular image feature sought to be detected (corresponding to first region 502) and the surrounding region thereof (corresponding to third region 506) may contribute to the resulting convolution value. On the contrary, if rescaled range 306 and convolution kernel 500 did not each include a respective negatively valued portion, the region surrounding the circular feature would not be able to contribute a positive signal component to the resulting convolution value. Thus, the circular image feature would instead be detectable using only first region 502 and second region 504, or variations thereof, resulting in the output convolution values having a lower signal-to-noise ratio. That is, inclusion of the negatively valued third region 506, in combination with rescaling of the initial pixel values of the input image, operates to improve a signal strength of the resulting convolution image.

Convolution kernel 500 may be rotationally symmetric. Thus, the resulting convolution image may be invariant to different orientations of convolution kernel 500. While fingerprint ridge ends are not perfectly circular, they are sufficiently circular to be detectable using convolution kernel 500. In some implementations, instead of using rotationally symmetric convolution kernel 500, keypoint detection system 300 may instead use a rotationally asymmetric kernel that more accurately resembles and/or models the shape of a ridge end.

FIG. 5B illustrates convolution kernel 520 that is rotationally asymmetric, and provides a second example of kernel 312. Specifically, convolution kernel 520 includes a first region 522, a second region 524, and a third region 526. First region 502 may approximately represent a union of a half-circle and a rectangle, second region 504 may surround first region 502, and third region 506 may surround second region 504. Thus, convolution kernel 520 may be configured to detect “finger-shaped” image features within the input image, where the finger-shaped image feature is similar to and/or approximated by the union of the half-circle and the rectangle as illustrated in FIG. 5B.

A discretized version of convolution kernel 520 is represented by kernel image 530, which includes a plurality of convolution pixels having respective values that approximate the values of regions 522, 524, and 526. Specifically, convolution pixels within boundary line 532 approximate first region 522, convolution pixels between boundary lines 532 and 534 approximate second region 524, and convolution pixels between boundary lines 534 and 536 approximate third region 526.

The values of regions 522, 524, and 526 (represented by corresponding kernel pixels of kernel image 530) may correspond to the values of regions 502, 504, and 506, respectively, of convolution kernel 500, but may have a different spatial distribution. Thus, whereas the values of regions 502, 504, and 506 are configured to improve detection of circular image features within the input image, the values of regions 522, 524, and 526 are configured to improve detection of finger-shaped image features (e.g., fingerprint ridge ends) within the input image.

Thus, first region 522 may include a plurality of positive values that represent the finger-shaped image feature, second region 524 may include a plurality of neutral values that represent a boundary between the finger-shaped image feature and surroundings thereof, and third region 526 may include a plurality of negative values that represent the surroundings of the finger-shaped image feature. For example, in the context of fingerprint minutiae detection, first region 522 may correspond to a ridge end, third region 526 may correspond to a valley surrounding the ridge end, and second region 524 may correspond to the ridge-valley boundary and/or transition.

Since convolution kernel 520 is rotationally asymmetric, determining the convolution image using convolution kernel 520 may include convolving the input image with convolution kernel 520 at a plurality of different orientations. For example, the plurality of orientations may include M different orientations, where the mth orientation may be expressed as m(360°)/M, and where 0≤m<M. For example, when M is equal to 8, convolution kernel 520 may be used to determine 8 orientation-specific kernels representing convolution kernel 520 rotated by 0°, 45°, 90°, 135°, 180°, 225°, 270°, and 315°, respectively, relative to a center of convolution kernel 520 in the orientation shown in FIG. 5B.

Each orientation-specific kernel may be convolved with the input image to determine a corresponding orientation specific convolution image. That is, the M orientation-specific kernels may be used to determine M orientation-specific convolution images. The M orientation-specific convolution images may be combined to form one final convolution image by taking a pixel-wise maximum of each pixel across the M orientation-specific convolution images. That is, the final convolution image may represent, for each respective pixel thereof, a highest value of the respective pixel across the M orientation-specific convolution images, thus representing the convolution value resulting from the kernel orientation that most closely matches the content of the input image at the respective pixel.

### VI. Additional Example Operations

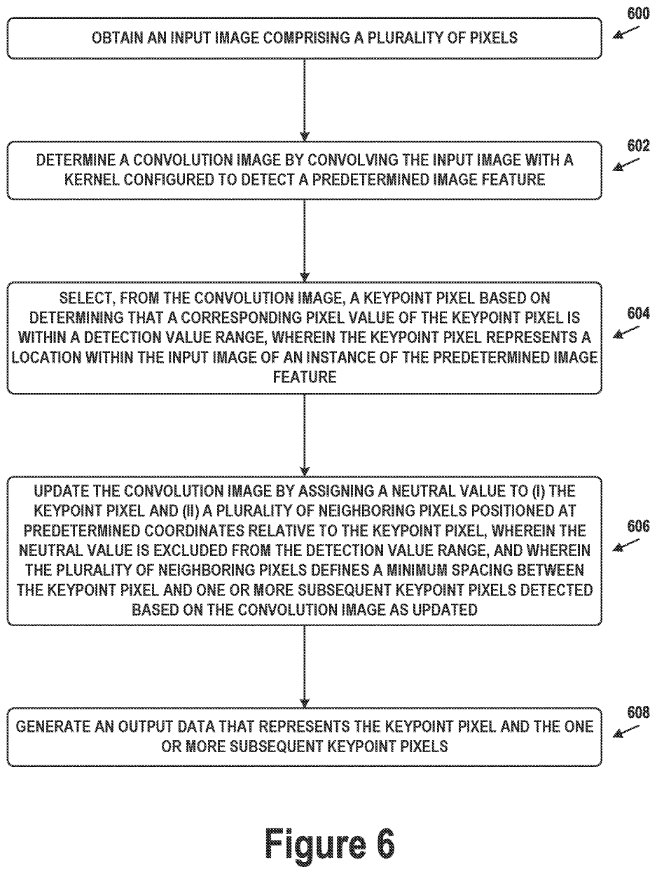

FIG. 6 illustrates a flow chart of operations related to a new technology. The operations may be carried out by computing device 100, computing system 200, and/or keypoint detection system 300 among other possibilities. The embodiments of FIG. 6 may be simplified by the removal of any one or more of the features shown therein. Further, these embodiments may be combined with features, aspects, and/or implementations of any of the previous figures or otherwise described herein.

Block 600 may involve obtaining an input image comprising a plurality of pixels.

Block 602 may involve determining a convolution image by convolving the input image with a kernel configured to detect a predetermined image feature.

Block 604 may involve selecting, from the convolution image, a keypoint pixel based on determining that a corresponding pixel value of the keypoint pixel is within a detection value range. The keypoint pixel may represent a location within the input image of an instance of the predetermined image feature.

Block 606 may involve updating the convolution image by assigning a neutral value to (i) the keypoint pixel and (ii) a plurality of neighboring pixels positioned at predetermined coordinates relative to the keypoint pixel. The neutral value may be excluded from the detection value range, and the plurality of neighboring pixels may define a minimum spacing between the keypoint pixel and one or more subsequent keypoint pixels detected based on the convolution image as updated.

Block 608 may involve generating an output data that represents the keypoint pixel and the one or more subsequent keypoint pixels.

In some embodiments, a rescaled image may be determined by mapping (i) initial values of the plurality of pixels of the input image to (ii) rescaled values selected from a rescaled range that extends from a predetermined negative pixel value to a predetermined positive pixel value. The convolution image may be determined by convolving the rescaled image with the kernel. Values of the kernel may correspond to the rescaled range.

In some embodiments, the kernel may include a first region, a second region, and a third region. The first region may include a plurality of positive values corresponding to a positive portion of the rescaled range and representing a body of the predetermined image feature. The second region may include a plurality of neutral values corresponding to a middle portion of the rescaled range and representing a boundary between the body of the predetermined image feature and a surrounding of the predetermined image feature. The third region may include a plurality of negative values corresponding to a negative portion of the rescaled range and representing the surrounding of the predetermined image feature.

In some embodiments, the second region may surround at least part of the first region, and the third region may surround at least part of the second region.

In some embodiments, the initial values may correspond to an initial range that extends from a minimum initial pixel value to a maximum initial pixel value. The initial range may be linearly mapped to the rescaled range such that the minimum initial pixel value is mapped to the predetermined negative pixel value, the maximum initial pixel value is mapped to the predetermined positive pixel value, and a midpoint of the initial range is mapped to a midpoint of the rescaled range.

In some embodiments, each of the minimum initial pixel value and the midpoint of the rescaled range may be a zero pixel value.

In some embodiments, the kernel may be rotationally symmetric.

In some embodiments, the kernel may be rotationally asymmetric, and determining the convolution image may include determining, for each respective orientation of a plurality of orientation of the kernel, a corresponding orientation-specific kernel. A plurality of orientation-specific convolution images may be determined by determining, for each respective orientation of the plurality of orientation of the kernel, a corresponding orientation-specific convolution image by convolving the input image with the corresponding orientation-specific kernel. The convolution image may be determined based on a pixel-wise maximum of the plurality of orientation-specific convolution images.

In some embodiments, the predetermined coordinates relative to the keypoint pixel may define a rectangular area centered on the keypoint pixel. A minimum horizontal spacing between the keypoint pixel and the one or more subsequent keypoint pixels may be based on a width of the rectangular area. A minimum vertical spacing between the keypoint pixel and the one or more subsequent keypoint pixels may be based on a height of the rectangular area. A maximum number of keypoint pixels detectable in the input image may be based on a number of pixels in the rectangular area.

In some embodiments, the detection value range may extend from (i) a threshold convolution value to (ii) a maximum pixel value. Selecting the keypoint pixel may include selecting, from the convolution image, the keypoint pixel having a highest corresponding pixel value that exceeds the threshold convolution value. The neutral value may be less than the threshold convolution value.

In some embodiments, the detection value range may extend from (i) a minimum pixel value to (ii) an inverted threshold convolution value. Selecting the keypoint pixel may include selecting, from the convolution image, the keypoint pixel having a lowest corresponding pixel value that is less than the inverted threshold convolution value. The neutral value may be greater than the inverted threshold convolution value.

In some embodiments, before selecting the keypoint pixel, the convolution image may be filtered by assigning the neutral value to pixels of the convolution image that have respective values that are excluded from the detection value range. The keypoint pixel may be selected from the convolution image as filtered. The one or more subsequent keypoint pixels may be selected from the convolution image as updated until a corresponding pixel value of all pixels of the convolution image as updated is equal to the neutral value.

In some embodiments, a second keypoint pixel may be selected from the convolution image as updated based on determining that a corresponding pixel value of the second keypoint pixel is within the detection value range. The second keypoint pixel may represent a second location within the input image of a second instance of the predetermined image feature. The second keypoint pixel may be one of the one or more subsequent keypoint pixels. The convolution image may be further updated by assigning the neutral value to (i) the second keypoint pixel and (ii) a second plurality of neighboring pixels positioned at the predetermined coordinates relative to the second keypoint pixel. The second plurality of neighboring pixels may define the minimum spacing between the second keypoint pixel and the one or more subsequent keypoint pixels detected based on the convolution image as further updated. The one or more subsequent keypoint pixels may be selected from the convolution image as further updated until a corresponding pixel value of all pixels of the convolution image as further updated is outside of the detection value range.

In some embodiments, a third keypoint pixel may be selected from the convolution image as updated based on comparing a corresponding pixel value of the third keypoint pixel to a second detection value range. The third keypoint pixel may represent a location within the input image of an instance of a second predetermined image feature. The third keypoint pixel may be one of the one or more subsequent keypoint pixels. A shape of the second predetermined image feature may correspond to a shape of the predetermined image feature, and a color of the second predetermined image feature may correspond to an inversion of a color of the predetermined image feature. The convolution image may be further updated by assigning the neutral value to (i) the third keypoint pixel and (ii) a third plurality of neighboring pixels positioned at the predetermined coordinates relative to the third keypoint pixel. The neutral value may be excluded from the second detection value range. The plurality of neighboring pixels may define the minimum spacing between the third keypoint pixel and the one or more subsequent keypoint pixels detected based on the convolution image as further updated.

In some embodiments, the input image may represent a fingerprint. The predetermined image feature may represent a fingerprint minutia. The output data may represent, using respective keypoint pixels, a plurality of fingerprint minutia detected within the input image.

In some embodiments, the fingerprint minutia may include one or more of a ridge end or a valley end.

In some embodiments, fingerprint verification data may be determined based on the input image and the output data. The fingerprint verification data may represent attributes of the plurality of fingerprint minutia detected within the input image. The fingerprint verification data may be compared to a fingerprint enrollment data that represents attributes of a second plurality of fingerprint minutia of a fingerprint that is authorized to unlock a computing device. A match score may be determined based on comparing the fingerprint verification data to the fingerprint enrollment data. It may be determined whether to unlock the computing device based on the match score.

In some embodiments, a second input image may be obtained. The second input image may include a second plurality of pixels and may represent the fingerprint that is authorized to unlock the computing device. A second convolution image may be determined by convolving the second input image with the kernel. A plurality of enrollment keypoint pixels may be determined by selecting, from the second convolution image, pixels having corresponding pixel values that are within the detection value range. The fingerprint enrollment data may be generated based on the plurality of enrollment keypoint pixels and the second input image.

### VII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A computer-implemented method comprising:
obtaining an input image comprising a plurality of pixels;
determining a convolution image by convolving the input image with a kernel configured to detect a predetermined image feature;
selecting, from the convolution image, a keypoint pixel based on determining that a corresponding pixel value of the keypoint pixel is within a detection value range, wherein the keypoint pixel represents a location within the input image of an instance of the predetermined image feature;
updating the convolution image by assigning a neutral value to (i) the keypoint pixel and (ii) a plurality of neighboring pixels positioned at predetermined coordinates relative to the keypoint pixel, wherein the neutral value is excluded from the detection value range, and wherein the plurality of neighboring pixels defines a minimum spacing between the keypoint pixel and one or more subsequent keypoint pixels detected based on the convolution image as updated; and
generating an output data that represents the keypoint pixel and the one or more subsequent keypoint pixels.

2. The computer-implemented method of claim 1, further comprising:
determining a rescaled image by mapping (i) initial values of the plurality of pixels of the input image to (ii) rescaled values selected from a rescaled range that extends from a predetermined negative pixel value to a predetermined positive pixel value, wherein the convolution image is determined by convolving the rescaled image with the kernel, and wherein values of the kernel correspond to the rescaled range.

3. The computer-implemented method of claim 2, wherein the kernel comprises:
a first region comprising a plurality of positive values corresponding to a positive portion of the rescaled range and representing a body of the predetermined image feature;
a second region comprising a plurality of neutral values corresponding to a middle portion of the rescaled range and representing a boundary between the body of the predetermined image feature and a surrounding of the predetermined image feature; and
a third region comprising a plurality of negative values corresponding to a negative portion of the rescaled range and representing the surrounding of the predetermined image feature.

4. The computer-implemented method of claim 3, wherein the second region surrounds at least part of the first region, and wherein the third region surrounds at least part of the second region.

5. The computer-implemented method of claim 2, wherein the initial values correspond to an initial range that extends from a minimum initial pixel value to a maximum initial pixel value, wherein the initial range is linearly mapped to the rescaled range such that the minimum initial pixel value is mapped to the predetermined negative pixel value, the maximum initial pixel value is mapped to the predetermined positive pixel value, and a midpoint of the initial range is mapped to a midpoint of the rescaled range.

6. The computer-implemented method of claim 5, wherein each of the minimum initial pixel value and the midpoint of the rescaled range is a zero pixel value.

7. The computer-implemented method of claim 1, wherein the kernel is rotationally symmetric.

8. The computer-implemented method of claim 1, wherein the kernel is rotationally asymmetric, and wherein determining the convolution image comprises:
determining, for each respective orientation of a plurality of orientation of the kernel, a corresponding orientation-specific kernel;
determining a plurality of orientation-specific convolution images by determining, for each respective orientation of the plurality of orientation of the kernel, a corresponding orientation-specific convolution image by convolving the input image with the corresponding orientation-specific kernel; and
determining the convolution image based on a pixel-wise maximum of the plurality of orientation-specific convolution images.

9. The computer-implemented method of claim 1, wherein the predetermined coordinates relative to the keypoint pixel define a rectangular area centered on the keypoint pixel, wherein a minimum horizontal spacing between the keypoint pixel and the one or more subsequent keypoint pixels is based on a width of the rectangular area, wherein a minimum vertical spacing between the keypoint pixel and the one or more subsequent keypoint pixels is based on a height of the rectangular area, and wherein a maximum number of keypoint pixels detectable in the input image is based on a number of pixels in the rectangular area.

10. The computer-implemented method of claim 1, wherein the detection value range extends from (i) a threshold convolution value to (ii) a maximum pixel value, and wherein selecting the keypoint pixel comprises:
selecting, from the convolution image, the keypoint pixel having a highest corresponding pixel value that exceeds the threshold convolution value, wherein the neutral value is less than the threshold convolution value.

11. The computer-implemented method of claim 1, wherein the detection value range extends from (i) a minimum pixel value to (ii) an inverted threshold convolution value, and wherein selecting the keypoint pixel comprises:
selecting, from the convolution image, the keypoint pixel having a lowest corresponding pixel value that is less than the inverted threshold convolution value, wherein the neutral value is greater than the inverted threshold convolution value.

12. The computer-implemented method of claim 1, further comprising:
before selecting the keypoint pixel, filtering the convolution image by assigning the neutral value to pixels of the convolution image that have respective values that are excluded from the detection value range, wherein the keypoint pixel is selected from the convolution image as filtered, and wherein the one or more subsequent keypoint pixels are selected from the convolution image as updated until a corresponding pixel value of all pixels of the convolution image as updated is equal to the neutral value.

13. The computer-implemented method of claim 1, further comprising:
selecting, from the convolution image as updated, a second keypoint pixel based on determining that a corresponding pixel value of the second keypoint pixel is within the detection value range, wherein the second keypoint pixel represents a second location within the input image of a second instance of the predetermined image feature, and wherein the second keypoint pixel is one of the one or more subsequent keypoint pixels; and
further updating the convolution image by assigning the neutral value to (i) the second keypoint pixel and (ii) a second plurality of neighboring pixels positioned at the predetermined coordinates relative to the second keypoint pixel, wherein the second plurality of neighboring pixels defines the minimum spacing between the second keypoint pixel and the one or more subsequent keypoint pixels detected based on the convolution image as further updated, and wherein the one or more subsequent keypoint pixels are selected from the convolution image as further updated until a corresponding pixel value of all pixels of the convolution image as further updated is outside of the detection value range.

14. The computer-implemented method of claim 1, further comprising:
selecting, from the convolution image as updated, a third keypoint pixel based on comparing a corresponding pixel value of the third keypoint pixel to a second detection value range, wherein the third keypoint pixel represents a location within the input image of an instance of a second predetermined image feature, wherein the third keypoint pixel is one of the one or more subsequent keypoint pixels, wherein a shape of the second predetermined image feature corresponds to a shape of the predetermined image feature, and wherein a color of the second predetermined image feature corresponds to an inversion of a color of the predetermined image feature; and
further updating the convolution image by assigning the neutral value to (i) the third keypoint pixel and (ii) a third plurality of neighboring pixels positioned at the predetermined coordinates relative to the third keypoint pixel, wherein the neutral value is excluded from the second detection value range, and wherein the plurality of neighboring pixels defines the minimum spacing between the third keypoint pixel and the one or more subsequent keypoint pixels detected based on the convolution image as further updated.

15. The computer-implemented method of claim 1, wherein the input image represents a fingerprint, wherein the predetermined image feature represents a fingerprint minutia, and wherein the output data represents, using respective keypoint pixels, a plurality of fingerprint minutia detected within the input image.

16. The computer-implemented method of claim 15, wherein the fingerprint minutia comprises one or more of a ridge end or a valley end.

17. The computer-implemented method of claim 15, further comprising:
determining, based on the input image and the output data, fingerprint verification data that represents attributes of the plurality of fingerprint minutia detected within the input image;
comparing the fingerprint verification data to a fingerprint enrollment data that represents attributes of a second plurality of fingerprint minutia of a fingerprint that is authorized to unlock a computing device;
determining a match score based on comparing the fingerprint verification data to the fingerprint enrollment data; and
determining whether to unlock the computing device based on the match score.

18. The computer-implemented method of claim 17, further comprising:
obtaining a second input image comprising a second plurality of pixels and representing the fingerprint that is authorized to unlock the computing device;
determining a second convolution image by convolving the second input image with the kernel;
determining a plurality of enrollment keypoint pixels by selecting, from the second convolution image, pixels having corresponding pixel values that are within the detection value range; and
generating the fingerprint enrollment data based on the plurality of enrollment keypoint pixels and the second input image.

19. A system comprising:
a processor; and
a non-transitory computer-readable medium having stored thereon instructions that, when executed by the processor, cause the processor to perform operations comprising:
obtaining an input image comprising a plurality of pixels;
determining a convolution image by convolving the input image with a kernel configured to detect a predetermined image feature;
selecting, from the convolution image, a keypoint pixel based on determining that a corresponding pixel value of the keypoint pixel is within a detection value range, wherein the keypoint pixel represents a location within the input image of an instance of the predetermined image feature;
updating the convolution image by assigning a neutral value to (i) the keypoint pixel and (ii) a plurality of neighboring pixels positioned at predetermined coordinates relative to the keypoint pixel, wherein the neutral value is excluded from the detection value range, and wherein the plurality of neighboring pixels defines a minimum spacing between the keypoint pixel and one or more subsequent keypoint pixels detected based on the convolution image as updated; and
generating an output data that represents the keypoint pixel and the one or more subsequent keypoint pixels.

20. A non-transitory computer-readable medium having stored thereon instructions that, when executed by a computing device, cause the computing device to perform operations comprising:
obtaining an input image comprising a plurality of pixels;
determining a convolution image by convolving the input image with a kernel configured to detect a predetermined image feature;
selecting, from the convolution image, a keypoint pixel based on determining that a corresponding pixel value of the keypoint pixel is within a detection value range, wherein the keypoint pixel represents a location within the input image of an instance of the predetermined image feature;
updating the convolution image by assigning a neutral value to (i) the keypoint pixel and (ii) a plurality of neighboring pixels positioned at predetermined coordinates relative to the keypoint pixel, wherein the neutral value is excluded from the detection value range, and wherein the plurality of neighboring pixels defines a minimum spacing between the keypoint pixel and one or more subsequent keypoint pixels detected based on the convolution image as updated; and
generating an output data that represents the keypoint pixel and the one or more subsequent keypoint pixels.
